(19) United States
(12) Patent Application Publication
(10) Pub. No.: US 2007/0023344 A1
(43) Pub. Date: Feb. 1, 2007

(54) Filter plate assembly and filter grid for filter press

(76) Inventor: Geoffrey D. Kemp, Mississauga (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/189,252

(22) Filed: Jul. 26, 2005

(51) Int. Cl. B01D 25/00

(52) U.S. Cl. 210/228; 210/231; 210/230

(57) ABSTRACT

A filter plate assembly for use in a filter press includes a frame made of two sealing frame members, each defining a rectangular aperture having a major and a minor dimension. A rectangular filter grid made of adjacent first and second sets of narrow bars fits in the frame. The bars of each set are parallel, are spaced apart from one another, and extend at a substantial angle to the bars of the other set. Each set of bars is bordered by a respective one of the frame members and defines a rectangle with a length and a width less than the length. The length of the rectangle formed by each set corresponds substantially to but does not exceed the length of the major dimension of the aperture in the sealing frame member bordering the respective set while the width of the rectangle corresponds substantially but does not exceed the minor dimension. The major dimension of the aperture in one frame member is perpendicular to the major dimension of the aperture in the other frame member.

### BACKGROUND OF THE INVENTION

This invention relates to filter plate assemblies for use in a filter press and filter grids for use in such assemblies.

Plate and frame filter presses have been used as commercial filtration devices for a substantial period of time and they are still widely used for the filtration of slurries and the washing of filter cake. The filter plates that are used in such filter presses can be made from a variety of materials, including fabricated steel, stainless steel and more recently various types of molded thermoplastic. The particular type of material chosen to construct the filter plate will often depend upon the particular application or the industry in which the filter press is being used. For example, the pharmaceutical and food industries prefer stainless steel as the product contact surface for most of their applications. Stainless steel is advantageous in that it is not subject to corrosion by most process fluids and is easy to clean. The ability to clean the components of the filter press thoroughly can be a critical factor in many industries and applications. Where the equipment cannot be economically disassembled, harsh chemicals can be pumped through the equipment to ensure that anything that may otherwise ferment or “grow” is rendered harmless. In some cases, the filtration equipment must be autoclaved which can also limit the selection of materials. If the equipment can be economically disassembled, there are commonly available procedures for checking that all surfaces are free from contamination.

U.S. Pat. No. 3,620,374 issued Nov. 16, 1971 to Joseph T. Kyerson & Son Inc. describes a reinforced plastic filter plate structure for use in a filter press. In the press, a plurality of filter plates are arranged between a fixed head and an adjustable head, the latter being movable into a clamping position by means of a screw and hand wheel. Filter cloths are held in place between the filter plates and adjacent frame members which alternate with the filter plates. The frames have a common inlet duct which communicate with passages, one for each frame, through which passes the incoming slurry or material to be filtered. The filter plates are made with a hole communicating with the duct for passage of the slurry and the upper ends of the plates have outlet passages communicating with holes forming part of an outlet duct. Each filter plate includes a frame to which are secured a plurality of rods which can include vertical rods and horizontal rods that are preferably made of a resin.

Published United Kingdom Patent Application No. 2165162A describes a filter press plate that includes two sets of parallel bars projecting from opposite sides of a central web. The bars can be orthogonal or parallel to each other and the structure can support filter cloths directly or inflatable membranes. This known structure can be molded in two pieces and removably located in a two-part frame.

It is an object of one aspect of the present invention to provide a filter device for use in a filter plate assembly that is economical to manufacture while at the same time being easy to use.

It is a further object of the invention according to another aspect to provide a novel filter plate assembly for use in a filter press which includes a filter grid that is easy to mount in a filter frame and which can be readily disassembled for cleaning purposes.

### SUMMARY OF THE INVENTION

According to one aspect of the invention, a filter plate assembly for use in a filter press includes a filter frame having two sealing frame members each forming a perimeter frame extending around and defining an aperture having a major dimension and a minor dimension. A filter grid is also provided and is made of adjacent first and second sets of bars with the bars of each set being parallel to each other and spaced apart from one another. The bars of one set extend at an angle to the bars of the other set and are bordered by a respective one of the frame members. The first and second sets define first and second areas each having a length and a width shorter than its length and the two sets are located on opposite sides of the grid. The length of the area formed by each set corresponds substantially to but does not exceed the major dimension of the aperture in the sealing frame member bordering the respective set. The width of the area formed by each set corresponds substantially to but does not exceed the minor dimension of the aperture in the sealing frame member bordering the respective set. The major dimension of the aperture in one of the frame members is perpendicular to the major dimension of the aperture of the other of the frame members and the length of the area defined by each set of bars is longer than the minor dimension of the sealing frame member bordering the other set of bars.

Preferably each bar of each set is elongate and a majority of the bars are tapered at both ends. In one preferred embodiment, the bars are elongate solid metal bars and the elongate bars of each set are welded to the elongate bars of the other set.

According to another aspect of the invention, a filter device for use in a filter plate assembly comprises a substantially rectangular filter grid made of adjacent, interconnected, first and second sets of bars with the bars of each set being parallel to each other. The bars of each set are spaced apart from one another and extend at a substantial angle to the bars of the other set. Each of the first and second sets substantially defines a rectangle and at least a major portion of the bars of one of the sets are tapered at ends of the bars located along one side edge of the grid and are tapered in the longitudinal direction of the bars.

In one preferred embodiment, the bars are elongate metal bars and the first set of bars are welded to the second set of bars.

According to a further aspect of the invention, a filter device for use in a filter plate assembly comprises a rectangular filter grid made from a unitary plate of relatively rigid material. The plate has first and second sets of bars on opposite sides thereof with the bars of each set being substantially parallel to each other and separated by grooves cut in the plate. The bars of each set extend at a substantial angle not exceeding 90 degrees to the bars of the other set and substantially define a rectangle. The grooves separating the bars of each set have a depth such that the grooves on the two opposite sides of the plate interconnect and form an array of holes in the filter grid.

In a particular preferred embodiment, all of the bars are tapered at both ends of each bar in the longitudinal direction of the respective bar.

Further features and advantages will become apparent from the following detail description of preferred embodiments taken in conjunction with the accompanying drawings.

### BRIEF DESCRIPTON OF THE DRAWINGS

FIG. 1 is an exploded perspective view showing the two sealing frame members of the filter frame and a filter grid constructed in accordance with the invention;

FIG. 2 is a front view of an assembled filter plate assembly constructed according to the invention;

FIG. 3 is a front view of a first sealing frame member with a rectangular aperture having a longitudinal axis extending vertically;

FIG. 4 is a front view showing the rectangular filter grid alone;

FIG. 5 is an edge view of the filter grid of FIG. 4;

FIG. 6 is a front view of a second sealing frame member having a rectangular aperture wherein the longitudinal axis extends horizontally;

FIG. 7 is a perspective view showing the inner surface of a single sealing frame member with the filter grid placed in the aperture of the frame member;

FIG. 8 is a perspective view showing an assembled filter frame with two sealing frame members and the filter grid mounted therein;

FIG. 9 is a front view of an alternate form of filter grid constructed in accordance with one aspect of the invention;

FIG. 10 is an edge view of the filter grid of FIG. 9;

FIG. 11 is an isometric view of a corner portion of the filter grid of FIG. 9;

FIG. 12 is an isometric view of a filter assembly that includes the filter frame, the filter grid, and an adjacent standard frame, all for use together in a filter press;

FIG. 13 is a cross-sectional detail to illustrate a sealing arrangement for the feed port pipe;

FIG. 14 is a front view of another embodiment of a filter plate assembly, this version having a heat exchange pipe mounted therein and forming part of the filter grid;

FIG. 15 is a top edge view of the filter plate assembly of FIG. 14;

FIG. 16 is a detail edge view showing the left portion of filter plate assembly of FIG. 15;

FIG. 17 is a detail front view showing the left, upper corner of the filter plate assembly of FIG. 14; and

FIG. 18 is a front view of yet another embodiment of a filter plate assembly.

### DETAILED DESCRIPTION OF PREFERRED EMBODIMENTS

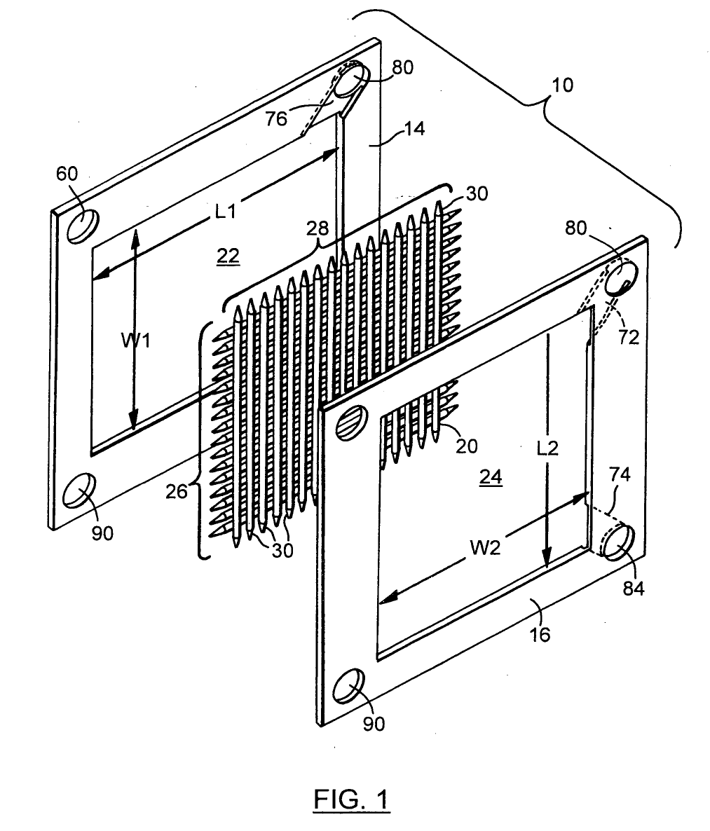

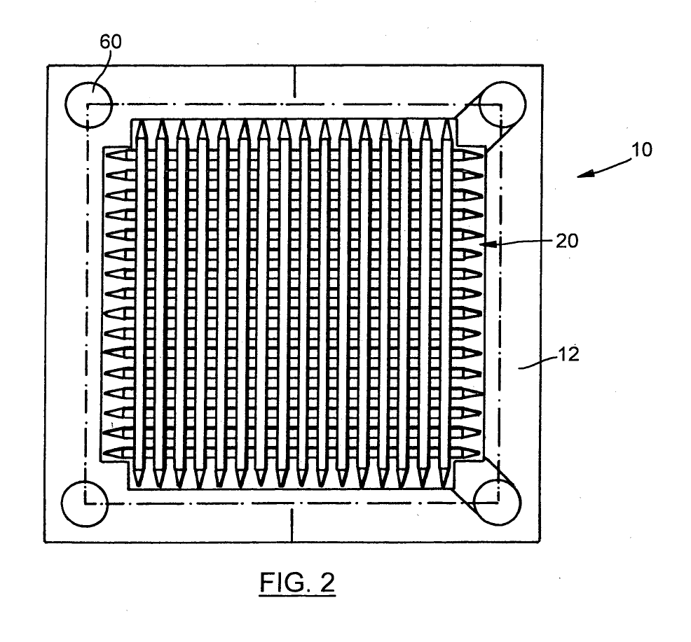

FIGS. 1 and 2 illustrate a preferred embodiment of a filter plate assembly 10 constructed in accordance with the invention and for use in a filter press. Except for the construction of the filter plate assembly and the filter grid therein, the filter press can be of known construction and accordingly a description of the filter press herein is deemed unnecessary. The filter press apart from the filter plate assembly can be of the type, for example, manufactured and sold by K-S Avery Filter Products Group of Komline-Sanderson of Brampton, Ontario, Canada. This filter plate assembly comprises two main components, these being a filter frame 12 having two sealing frame members 14, 16 and a rectangular filter grid 20. Each frame member 14, 16 forms a perimeter frame extending around and defining a substantially rectangular aperture 22, 24. Each of these apertures can have a major dimension or length and a minor dimension or width. In the case of the aperture 22, the major dimension is in the horizontal direction and is indicated by L1 while the minor dimension is indicated by W1. In the case of the other aperture 24, the major dimension extends vertically and is indicated by L2 while the minor dimension is indicated by W2.

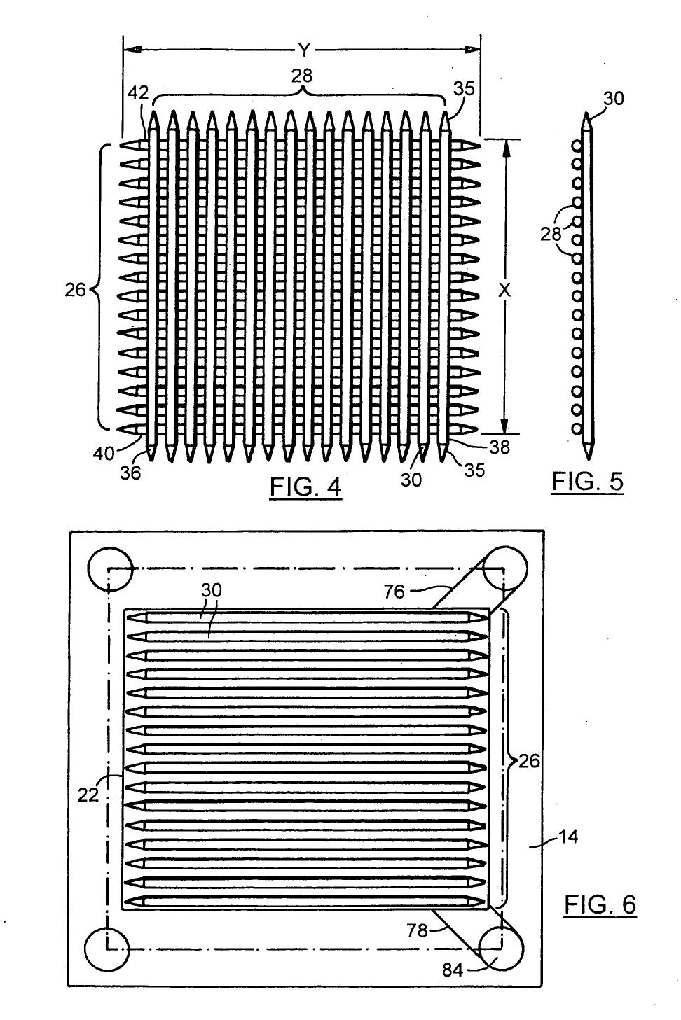

According to one form of the filter grid 20, the grid comprises adjacent first and second sets 26, 28 of narrow, elongate bars 30. The bars 30 of each set are substantially parallel to each other and are spaced apart from one another. In one preferred embodiment of the grid, the bars or rods 30 are spaced apart a distance slightly less than the diameter of each bar or rod. With particular reference to FIGS. 4 and 5 wherein the bars 30 can be seen more clearly and the grid is shown separately, the bars of the first set 26 extend at a substantial angle to the bars of the other set and preferably are perpendicular to the bars of the other set 28. Furthermore, it will be seen that each of the first and second sets substantially defines a rectangle with a length and a width. The length of the first set 26 being indicated by Y and being equal to the length of each of the bars 30. The width of the rectangle formed by the first set 26 is indicated by X. Thus, in the embodiment of the filter grid shown in FIGS. 4 and 5, the length Y of the rectangle is greater than the width X. The two sets of bars 26 and 28 are located on opposite sides of the filter grid.

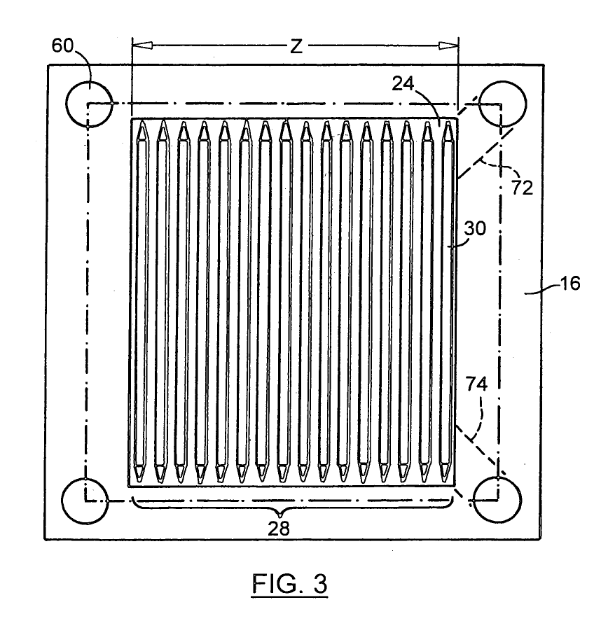

With reference now to FIGS. 3 and 6 of the drawings, FIG. 3 illustrates the arrangement of the vertically extending second set of bars 28 relative to the frame member 16 while FIG. 6 illustrates the arrangement of the horizontally extending first set of bars 26 relative to the frame member 14. The first set of bars 26 forms a rectangle which substantially fills the aperture 22 in the frame 14. Thus, the length Y of the individual bars 30 in the first set 26 corresponds to the dimension L1 of the aperture 22. Also the dimension X of the rectangle formed by the first set 26 corresponds substantially to but does not exceed the dimension W1 of the aperture 22. Thus, the first set of bars 26 are sized and arranged to fit completely within the aperture 22, including the depth of the aperture, that is, the dimension perpendicular to the plane of the frame member 14. Similarly and with reference to FIG. 3, the length of each bar 30 in the second set 28 corresponds substantially to but does not exceed the vertical distance L2 of the aperture 24 while the dimension Z of the rectangle formed by the set 28 corresponds substantially to but does not exceed the horizontal dimension W2 of the aperture. Thus, the second set of bars 28 is arranged and sized to fit within the rectangular aperture 24, including the depth of the aperture.

Furthermore, as can be seen from FIGS. 1 and 2, the major dimension L1 of the aperture 22 in the frame member 14 is perpendicular to the major dimension L2 of the aperture 24 of the other frame member. In addition, the length of the rectangle defined by each set of bars 26, 28 is longer than the minor dimension of the sealing frame member bordering the other set of bars. Thus, the length of the rectangle formed by the bars 26 is longer than the minor dimension W2 of the frame member 16 which borders the bars 28. Similarly, the length of the rectangle formed by the bars 28 is longer than the minor dimension W1 of the frame member 14 which borders the bars 26.

With respect to the preferred construction of the two sets of bars or rods 26, 28, in one preferred embodiment all of the bars in each set are tapered at both ends as shown in the drawings. Thus, in the case where the bars have a circular cross-section, each end of the bar can have a conical end section 35. By providing the tapered ends, an edge region is provided along the filter grid to allow filtrate to pass readily to filtrate collection ports in corners of the filter plate assembly when the filter press is in operation. It is highly desirable that the bottom ends of the vertical bars 28 be tapered in order to ensure that a drainage passage exists at the bottom of the grid to allow the filtrate to flow to one or two bottom filtrate ports. One preferred material for the rods 30 is a suitable metal such as stainless steel. The particular metal chosen will dependent to some extent on the particular filtration process for which the filter plate assembly is to be used. For some applications, the rods 30 can be made of a rigid plastic material, such as polypropylene.

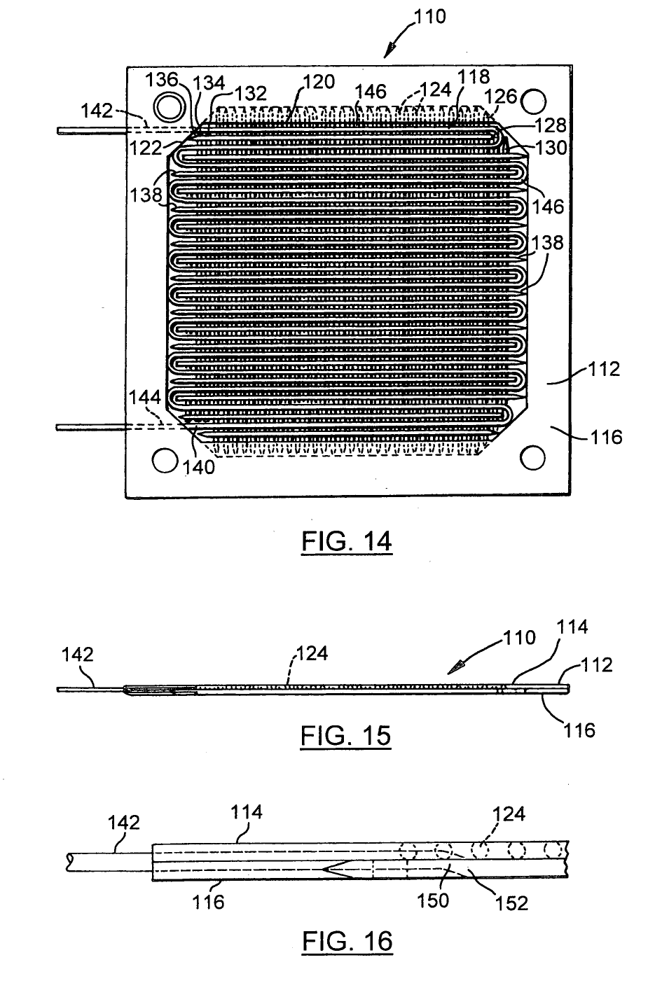

In one preferred construction employing metal rods or bars 30, the two outer rods 36, 38 of the second set of rods 28 are welded to each of the rods 30 of the first set 26. Similarly, the outer rods 40, 42 of the first set 26 are welded to each of the rods in the second set 28. By welding the rods around the perimeter of the filter grid in this manner, the two sets of rods are effectively held together as a fixed grid. Of course, it is also possible to weld together the two sets of bars at all contact points between the bars but this number of welds is not required for many applications. Also, instead of using solid bars or rods, an optional arrangement for the filter grid is to replace some of the illustrated rods with hollow tubing which allow a heating or cooling medium to be introduced to the cake formation area and which may be desirable for some filtration processes. One filter plate assembly that uses tubing is described below with reference to FIGS. 14 to 17.

In the illustrated preferred embodiment of the filter grid shown in FIGS. 4 and 5, the solid bars 30 are rods having a circular cross-section for at least a major portion of their lengths.

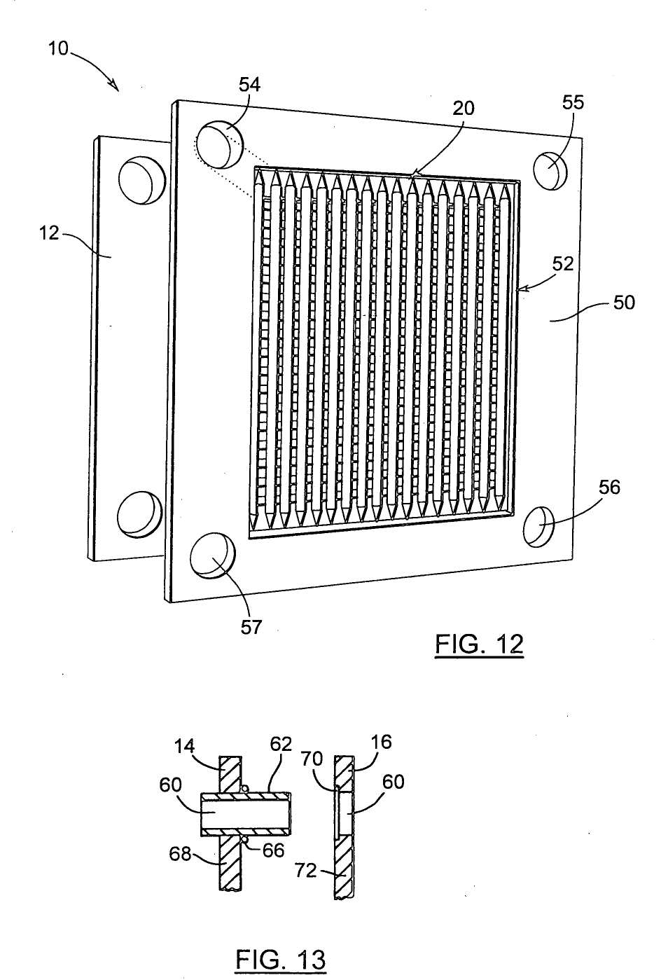

It will be understood by those skilled in the use of filter presses that the filter plate assembly 10 of the invention can be used in a filter press with a standard, rectangular frame of similar dimensions. A standard frame 50 of this type is shown in FIG. 12. As shown, this additional frame 50 has a length and a width in the plane of the frame similar to corresponding dimensions of the filter frame 12 and forms a substantial rectangular opening 52 which forms an open area adjacent the filter grid 20. It will be understood that the filtered out material or filter cake is collected in the open area formed by the opening 52. The frame 50 can be provided with four circular corner holes 54 to 57, at least one of which can be a corner feed port.

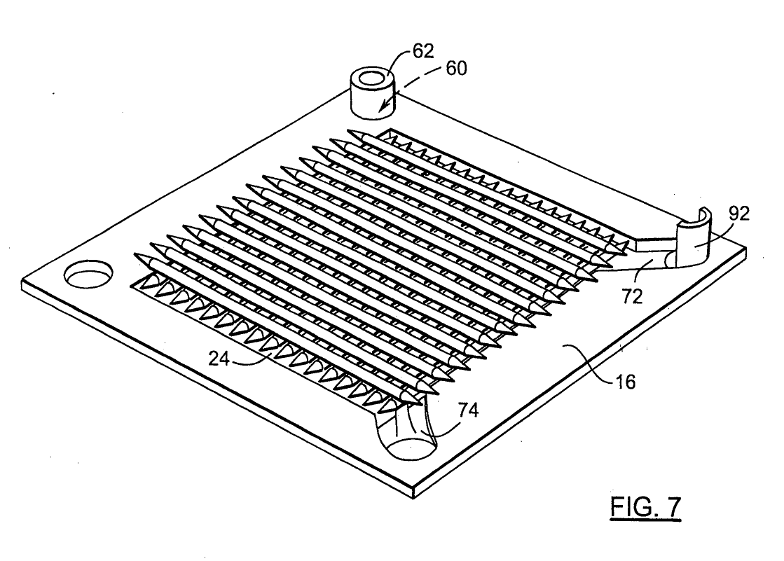

With reference to FIGS. 1 and 3 wherein the frame member 16 is shown, this frame member is provided with a feed port 60 in the form of a circular hole in one of the four corners. One of the two sealing frame members or plates 14, 16, in the present case the frame member 14, is fitted with short section of pipe 62 shown in FIG. 7 but not in FIGS. 1 and 6. This short pipe extends into the feed port 60 and is fixedly connected to the frame member. The slurry that is fed into the filter press passes through the pipes 62. When the two frame members 14 and 16 are arranged side-by-side as shown in FIG. 8, a short end portion 64 of the pipe 62 projects from the outer surface of the frame member 16. It will be understood that this short end portion 64 extends into the above described standard frame 50 shown in FIG. 12 but a passage must be left to allow slurry to flow into the frame 50 where the filtration occurs. It is convenient for the pipe 60 to extend beyond the face of frame member 16 as the pipe can then be used to hang the filter cloth/paper when setting up the press. However, it is not essential for the pipe 60 to extend in this manner as the filter medium can be draped over the assembled filter press frames or suspended from specially provided points positioned above the outside of the adjacent standard frames 50.

As shown in the cross-sectional detail view of FIG. 13, there is preferably mounted on the pipe 62 an O-ring 66 that is arranged on the inner surface 68 of the frame member 14. In order to accommodate this O-ring, an annular recess 70 is formed around the feed port 60 of the frame member 16 on the latter's inside surface 72. The purpose of this O-ring seal is to ensure that no slurry can by-pass the filter medium that covers both sides of the filter grid and contaminate the filtrate. As known in the filter press art, the slurry is fed by means of the feed ports 60 and the short pipe sections 62 to inlet channels formed in the respective corners of the adjacent frames 50. The slurry flows into the open area formed by the rectangular aperture in each frame 50 from which it passes through the filter medium and into the space filled by the filter grid 20 which supports the filter medium. Then, one or more channels are provided to allow the filtrate to pass to filtrate collection ports in corners of the filter plate assembly. As shown in FIGS. 1 and 3, there can be two channels 72, 74 formed in the frame member 16 and a further two channels 76, 78 formed in the frame member 14. The two channels 72, 76 combine together to form a filtrate passage leading to filtrate port 80 formed in the frame members 14 and 16. Similarly, the channels 74, 78 combine together to form a filtrate passage leading to filtrate port 84. The ports having the drainage passageways can either be the two ports on the side of the plate opposite to the feed port 60 (as shown) or the filtrate port can be on the same side as the feed port, that is, at the location of the corner holes 90 shown in FIG. 1. By locating the filtrate port or ports in this manner, the arrangement allows for cake wash and blow.

Also shown in FIG. 7 is a partial pipe section 92 which can be mounted to the frame member 14 at one of the filtrate ports. The partial pipe section 92 is preferably provided if the feed port 60 is in one of the upper corners of the filter plate assembly (as it is in the illustrated embodiment). It is provided in the other upper corner of the assembly for the convenience of hanging the filter medium being used in the filter press.

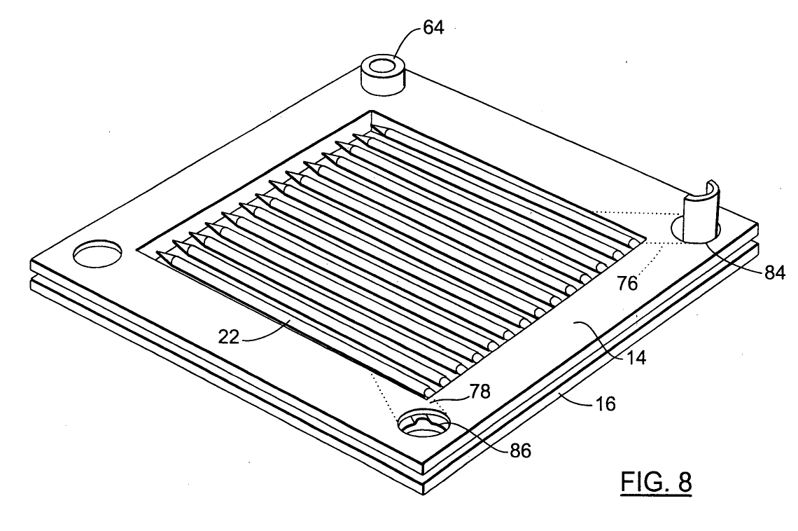

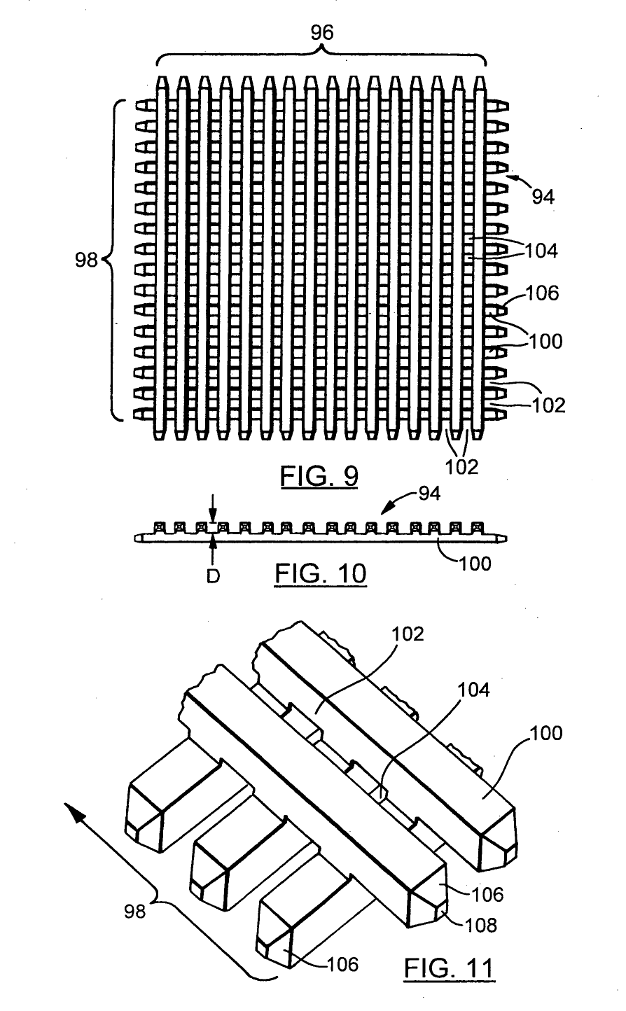

FIGS. 9 to 11 illustrate an alternate form of filter device for use in a filter plate assembly constructed in accordance with this invention, this filter device comprising a rectangular filter grid 94. It will be understood that this filter grid can be used in combination with the above described sealing frame members 14, 16 in place of the filter grid 20 shown in FIGS. 4 and 5. The filter grid 94 is made from a unitary plate of relatively rigid material, such as a suitable plastics material or even metal. A preferred plastic for many applications is polypropylene. The filter grid has a first set 96 of narrow, elongate bars which extend parallel to each other and a second set 98 of narrow elongate bars 100 which also extend parallel to each other. The two sets of bars are adjacent to and are attached to each other but are located on opposite sides of the filter grid 94. The bars of each set are separated by grooves 102 cut in the plate. The grooves 102 can be cut by means of a radial arm saw of known construction. The advantage of this form of manufacture of the filter grid is that it is relatively easy to design and construct a variety of different filter grids of various sizes and layout.

As with the filter grid 20, the bars of each set extend perpendicular to the bars of the other set and define a rectangle. The grooves 102 separating the bars of each set have a depth indicated at D such that the grooves on the two opposite sides of the filter grid interconnect and form an array of holes 104 in the filter grid.

As with the filter grid 20, at least a major portion of the bars 100 are tapered at at least one end of each bar in the longitudinal direction of the respective bar. This taper is indicated at 106. In the illustrated embodiment, the taper is in the form of a four sided pyramid having a square flat top at 108. It will be appreciated that it is relatively easy to cut each end of each bar in this manner using standard cutting tools. In the preferred illustrated embodiment, all of the bars 100 are in fact tapered at both ends of each bar in the longitudinal direction of the respective bar.

If metal is used to construct the filter grid 94, the preferred metal is one resistant to corrosion such as stainless steel.

The filter plate assembly 10 is preferably assembled in the manner illustrated by FIGS. 7 and 8. Initially one of the sealing plates or frame members 14, 16 is placed on a flat surface. This frame member can be the frame member 16 shown in FIG. 7 and the frame member is placed so that the pipe 62 extends upwardly and the channels 72, 74 face upwardly. Then the filter grid 20 is placed on top of the frame member 16 as shown so that one set of the bars (that is, the lower set) is inserted into the aperture 24. As shown in FIG. 7, the bars should substantially fill the rectangular aperture. Then the other sealing plate or frame member, in this case the frame member 14, is placed over the filter grid 20 as shown in FIG. 8. The top set of bars then substantially fill the aperture 22 formed in the frame member 14. This completes the assembly of the filter plate arrangement. The two frame members 14, 16 can then be held together during the filtration process by standard clips or fasteners (not shown).

Another form of filter plate assembly 110 is illustrated in FIGS. 14 to 17 of the drawings. The construction of this filter plate assembly is similar to the filter plate assembly 10 shown in FIG. 1 except for the differences noted hereinafter. Again, the filter plate assembly includes two main components, these being a filter frame 112 having two sealing frame members 114 and 116 and a substantially rectangular filter grid 118. Each of the frame members 114, 116 forms a perimeter frame extending around and defining a substantially rectangular aperture, an aperture 120 being formed in the frame 116. In this embodiment, the four corners of each aperture are cut off at a 45 degree angle as indicated at 122.

The construction of the filter grid 118 differs from that of the embodiment of FIG. 1. As illustrated, there is a first set of vertically extending, elongate bars 124, most of which are tapered at both ends. However, due to the cut off corners, the three illustrated bars on the right side of FIG. 14 have a reduced length. These include the vertical bars 126, 128 and 130 with the bar at 128 being slightly shorter than the bar at 126 and the bar at 130 being slightly shorter than the bar 128. All three of these reduced length bars have tapered ends. On the left side of FIG. 14 there are three further vertical bars of reduced length, these being bars 132, 134 and 136. These three bars are substantially the same length and two of these bars have no tapered ends.

There is also a second set of elongate bars that extend horizontally, these bars indicated generally by reference 138. These bars can be tapered at one end only, either the left end or the right end. The bars 138 with a taper on the left end alternate with the bars 138 with the taper on their right ends. In addition to these solid bars 138, there is an elongate, sinusoidal tube 140 that enables the filter plate assembly 110 to be heated or cooled as the filtering process may require. For example, the tube 140 may provide a passageway for the passage of steam or some other form of heat exchange fluid. An inlet end 142 for the tube can be provided near the upper edge of the plate assembly, while an outlet 144 can be provided near the bottom edge of the assembly at one corner. It will be appreciated that the straight sections 146 of the sinusoidal tube themselves form alternating bars of the horizontal bar set. Thus the sinusoidal tube 140 itself forms part of the filter grid 118. The tube 140 has a number of 180 degree bends 146 with the outer extremity of these bends on one side being aligned with the points of the adjacent elongate bars 138.

In order for the inlet and outlet end sections of the tube at 142 and 144 to run in grooves on the inner surfaces of the frame members and to run between the frame members, each end section of the tube is bent twice at 150 and 152 as illustrated in FIG. 16. In other words, the tube undergoes a double bend near the ends of the vertical bars 132 to 136 and this is why these bars are made shorter.

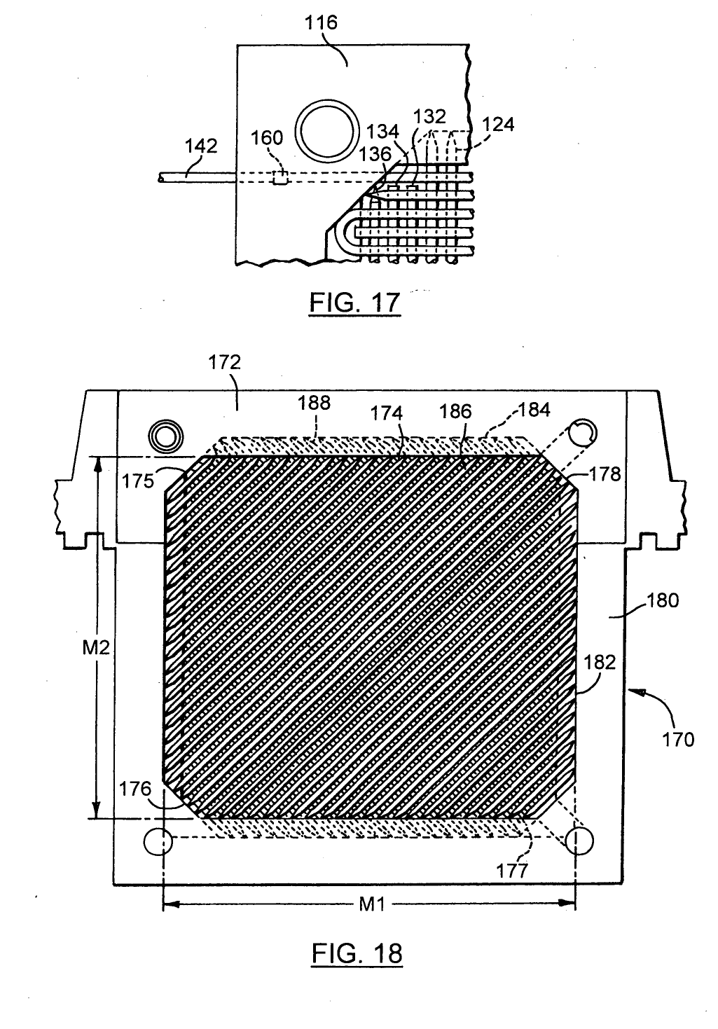

As shown in the detail view of FIG. 17, in order to prevent leakage of material through the passageway formed for either the inlet section or the outlet section of the tube, a sealing groove can again be provided, the groove 160 for the inlet section being shown. The sealing groove accommodates a standard annular seal that sealing engages the exterior of the tube 142. This seal can be an O-ring seal.

FIG. 18 illustrates another embodiment of a filter plate assembly constructed in accordance with the invention, this embodiment being indicated generally as 170. It will be understood that this filter plate assembly is constructed in a manner similar to the filter plate assembly 10 of FIGS. 1 to 3 except for the differences noted hereinafter. The assembly 170 also comprises two main components, this being a filter frame 172 and a filter grid 174 which is substantially rectangular. However, unlike the filter grid 20, the grid 174 has it four corners cut off or removed, these cut-off corners being indicated at 175 to 178. As with the first embodiment, each of the two sealing frame members, including sealing frame member 180 define an aperture 182, 184 having a major dimension and a minor dimension. Thus with respect to the aperture 182, the major dimension is indicated at M1 while the minor dimension is indicated at M2.

The filter grid 174 comprises adjacent first and second sets of bars with a first set 186 shown as sloping upwardly to the right in FIG. 18 and the second set 188, which is behind the first set 186, being shown sloping upwardly to the left. Each set is bordered by a respective one of the sealing frame members. The first and second sets define first and second areas each having a length and a width shorter than its length. The length of the area formed by the first set 186 corresponds substantially but does not exceed the major dimension M1 of the aperture 182 bordering this set. Similarly the length of the area formed by the second set 188 corresponds substantially to but does not exceed the major dimension of the aperture 184 bordering the second set. Similarly the width of the area formed by each set corresponds substantially but does not exceed the minor dimension of the aperture in the sealing frame bordering the respective set. Thus, for example, the width of the area formed by the first set 186 corresponds substantially to but does not exceed the minor dimension of the aperture 182. It will also be seen that the major dimension of the aperture 182 in the sealing frame member 180 is perpendicular to the major dimension of the aperture 184 of the other sealing frame member. Also the length of the area defined by each set of bars is longer than the minor dimension of the sealing frame member bordering the other set of bars.

In the particular preferred embodiment illustrated in FIG. 18, the bars of the first set 186 extend at an acute 45° angle to the top and bottom edges of the filter plate assembly. Similarly, the bars of the second set 188 extend at an 45° angle to the top and bottom edges of the filter plate assembly. In the result, the two sets of bars are arranged so that they are perpendicular to one another. It will also be noted that in this embodiment the length of the bars in each set varies substantially. The bars of maximum length extend between two opposite corners of the sealing frame member while the bars having the shortest length are located at the remaining two corners of the sealing frame member.

It will be appreciated that various modifications and changes can be made to the filter plate assembly and filter grids described herein without departing from the spirit and scope of this invention. Accordingly, all such modifications and changes as fall within the scope of the appended claims are intended to be part of this invention.

I claim:

1. A filter plate assembly for use in a filter press, comprising:
a filter frame having two sealing frame members each forming a perimeter frame extending around and defining a substantially rectangular aperture having a major dimension and a minor dimension; and
a rectangular filter grid made of adjacent first and second sets of bars with the bars of each set being parallel to each other, being spaced apart from one another, extending at an angle to the bars of the other set, and being bordered by a respective one of the frame members, each of said first and second sets substantially defining a rectangle with a length and a width and the two sets being located on opposite sides of the grid, the length of the rectangle formed by each set corresponding substantially to but not exceeding the major dimension of the aperture in the sealing frame member bordering the respective set, the width of the rectangle formed by each set corresponding substantially to but not exceeding the minor dimension of the aperture in the sealing frame member bordering the respective set,
wherein the major dimension of the aperture in one of said frame members is perpendicular to the major dimension of the aperture of the other of the frame members and the length of the rectangle defined by each set of bars is longer than the minor dimension of the sealing frame member bordering the other set of bars.

2. A filter plate assembly according to claim 1 wherein each bar of each set is elongate and a majority of the bars are tapered at both ends.

3. A filter plate assembly according to claim 2 wherein said bars are elongate solid metal bars and the elongate bars of each set are welded to the elongate bars of the other set.

4. A filter plate assembly according to claim 2 wherein said rectangular grid is formed from a single panel of plastics material and the elongate bars of one set are integrally joined to the elongate bars of the other set.

5. A filter plate assembly according to claim 1 wherein said bars are elongate rods having a circular cross-section for at least a major portion of their lengths and the width of the space separating adjacent rods in each set is less than the diameter of the rods in the respective set.

6. A filter plate assembly according to claim 2 wherein a feed port is formed in one corner of the sealing frame members, a short pipe is attached to one of said sealing frame members at the feed port, an annular recess is formed around a hole in the other of said sealing frame members, said hole being part of said feed port, and an “O” ring seal is mounted in said annular recess in order to seal around said short pipe where adjacent surfaces of the two sealing frame members meet.

7. A filter plate assembly according to claim 1 wherein the bars of each set extend perpendicular to the bars of the other set.

8. A filter plate assembly according to claim 7 wherein the sealing frame members are formed with at least one port for filtrate in one corner thereof and at least one channel for passage of filtrate extending between said at least one port and the apertures formed by the frame members, said at least one channel being located on or at the inner sides of the frame members that face each other.

9. A filter plate assembly according to claim 3 wherein the sealing frame members are formed with at least one port for filtrate in one corner thereof and at least one channel for passage of filtrate extending between said at least one port and the apertures formed by the frame members, said at least one channel being located on or at the inner sides of the frame members that face each other.

10. A filter plate assembly according to claim 7 wherein at least some of the bars are provided by at least one hollow tube through which a cooling or heating medium can be passed during operation of the filter press.

11. A filter plate assembly according to claim 2 including an additional frame having a length and a width similar to corresponding dimensions of said filter frame and forming a substantially rectangular opening, said additional frame being adapted for mounting in said filter press adjacent to one side of said filter frame.

12. A filter device for use in a filter plate assembly, said filter device comprising a substantially rectangular filter grid made of adjacent, interconnected first and second sets of bars with the bars of each set being parallel to each other, being spaced apart from one another, and extending at a substantial angle to the bars of the other set, each of the first and second sets substantially defining a rectangle, wherein at least a major portion of the bars of one of said sets are tapered at ends of the bars located along at least one side edge of the grid and are tapered in the longitudinal direction of the bars.

13. A filter device according to claim 12 wherein said bars are metal bars and the first set of bars are welded to said second set of bars.

14. A filter device according to claim 12 wherein all of the bars of each set are tapered at both ends of each bar.

15. A filter device according to claim 12 wherein the bars of each set extend substantially perpendicular to the bars of the other set.

16. A filter device according to claim 15 wherein the bars of each set extend at an acute angle to side edges of the filter grid.

17. A filter device according to claim 16 wherein the bars of each set extend at an approximate 45 degrees angle to side edges of the filter grid.

18. A filter device according to claim 12 wherein said filter grid is formed from a single panel of relatively rigid plastics material, the bars of one set are integrally joined to the bars of the other set, and the bars of both sets are elongate.

19. A filter device according to claim 12 wherein the bars are elongate, the bars of one set extend perpendicular to the bars of the other set, and two outer bars of each set are welded to all of the bars of the other set to fix the position of all bars relative to one another.

20. A filter device for use in a filter plate assembly, said filter device comprising a rectangular filter grid made from a unitary plate of relatively rigid material, said filter grid having first and second sets of bars on opposite sides thereof with the bars of each set being parallel to each other and separated by grooves cut in the plate, the bars of each set extending at a substantial angle not exceeding 90 degrees to the bars of the other set and substantially defining a rectangle, the grooves separating the bars of each set having a depth such that grooves on the two opposite sides of the filter grid interconnect and form an array of holes in the filter grid.

21. A filter device according to claim 20 wherein at least a major portion of the bars of one of the sets are tapered at ends of the bars located along at least one side edge of the grid and are tapered in the longitudinal direction of the bars.

22. A filter device according to claim 20 wherein said relatively rigid material is a plastics material.

23. A filter device according to claim 20 wherein the majority of the bars are tapered at both ends of each bar in the longitudinal direction of the respective bar.

24. A filter device according to claim 21 wherein the width of the grooves is substantially the same as the width of the bars in each set and the grooves on both sides of the filter grid have the same uniform width.

25. A filter device according to claim 21 wherein said relatively rigid material is polypropylene.

26. A filter device according to claim 20 wherein the bars of each set extend perpendicular to the bars of the other set.

27. A filter device according to claim 23 wherein the bars of each set extend perpendicular to the bars of the other set.

28. A filter plate assembly for use in a filter press, comprising:
a filter frame having two sealing frame members each forming a perimeter frame extending around and defining an aperture having a major dimension and a minor dimension; and
a filter grid made of adjacent first and second sets of bars with the bars of each set being parallel to each other, being spaced apart from one another, extending at an angle to the bars of the other set, and being bordered by a respective one of the frame members, said first and second sets defining first and second areas each having a length and a width shorter than its length and the two sets being located on opposite sides of the grid, the length of the area formed by each set corresponding substantially to but not exceeding the major dimension of the aperture in the sealing frame member bordering the respective set, the width of the area formed by each set corresponding substantially to but not exceeding the minor dimension of the aperture in the sealing frame member bordering the respective set,
wherein the major dimension of the aperture in one of said frame members is perpendicular to the major dimension of the aperture of the other of the frame members and the length of the area defined by each set of bars is longer than the minor dimension of the sealing frame member bordering the other set of bars.

29. A filter plate assembly according to claim 28 wherein each bar of each set is elongate and a majority of the bars are tapered at both ends.

30. A filter plate assembly according to claim 29 wherein said bars are elongate solid metal bars and the elongate bars of each set are welded to the elongate bars of the other set.
